(19) United States
(12) Patent Application Publication
(10) Pub. No.: US 2008/0187074 A1
(43) Pub. Date: Aug. 7, 2008

(54) METHOD AND APPARATUS FOR CONTROLLING ANALOG BLOCK OF DATA RECEIVER

(75) Inventor: Jae-young Kwak, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD, Suwon-si (KR)

(21) Appl. No.: 11/748,272

(22) Filed: May 14, 2007

(30) Foreign Application Priority Data
Feb. 2, 2007 (KR) 10-2007-0011254

(51) Int. Cl. H04L 27/00

(52) U.S. Cl. 375/316

(57) ABSTRACT

Provided are a method and apparatus for controlling an analog block of a data receiver, and a data receiver using the same. The apparatus for controlling an analog block of a data receiver having the analog block and a digital block, includes a controller unit which determines whether to reconfigure a control signal required to control the analog block; a control signal determining unit which determines a new control signal by using digital data obtained from the digital block according to a determination result of the controller unit; and a control signal generator unit that generates an electrical control signal in response to the new control signal determined by the control signal determining unit. Accordingly, errors of received data can be more effectively prevented since environment changes of a transmission channel can be adaptively handled.

### CROSS-REFERENCE TO RELATED PATENT APPLICATION

This application claims priority from Korean Patent Application No. 10-2007-0011254, filed on Feb. 2, 2007, in the Korean Intellectual Property Office, the disclosure of which is incorporated by reference in its entirety.

### BACKGROUND OF THE INVENTION

1. Field of the Invention

Methods and apparatuses consistent with the present invention relate generally to a data transceiver, and more particularly, to controlling an analog block of a data receiver.

2. Description of the Related Art

High definition multimedia interface (HDMI) is an interface standard which has been developed and updated up to the current version of 1.3. Under this interface standard, there is a high transmission rate of data as video/audio data are processed with a serialization transform and are transmitted through a cable in the format of differential signals. According to the HDMI, video and audio signals are transmitted from one device to another device. The HDMI is used in many digital video devices such as a high definition television (HDTV), a digital video disk (DVD) player, a set-top box (STB), and a camcorder.

In the HDMI, a signal transmitted through a cable that connects two or more devices conforms to a transition minimized differential signaling (TMDS) standard which is included in the HDMI standard. Therefore, a HDMI data receiver includes a TMDS reception analog block so as to restore analog data received by the HDMI data receiver to digital data.

However, when a sampling error such as noise or skew occurs in a TMDS channel, erroneous data is received by the HDMI data receiver. Furthermore, an error frequency of the received data increases in proportion to a high data transmission rate (3.4 GHz at present). Therefore, it becomes more difficult for a data receiving end (sink) to restore data.

In order to solve these problems, control signals to control the TMDS reception analog block are conventionally adjusted according to a data transmission rate (or a HDMI operation frequency band) in order to reduce the occurrence of erroneous data.

However, the conventional method is a non-flexible control method and thus has a limit in preventing erroneous received data because, besides changes in the operation frequency band, changes in a type of a transmitter (source), a type and length of a connection cable, a surrounding environment, and other various factors affect a state of a transmission channel and cause transmission errors.

### SUMMARY OF THE INVENTION

The present invention provides a method and apparatus for adaptively controlling a transition minimized differential signaling (TMDS) analog block in order to prevent the occurrence of erroneous received data.

According to an aspect of the present invention, there is provided an apparatus for controlling an analog block of a data receiver having the analog block and a digital block, the apparatus including: a controller unit which determines whether to reconfigure a control signal required to control the analog block; a control signal determining unit which determines a new control signal by using digital data obtained from the digital block according to a determination result of the controller unit; and a control signal generator unit which generates an electrical control signal corresponding to the new control signal determined by the control signal determining unit.

According to another aspect of the present invention, there is provided a data receiver including: an analog block which restores analog data received from a transmission channel to digital data; a digital block which decodes the digital data restored by the analog block to audio/video data; and an analog block controller which controls the analog block, wherein the analog block controller reconfigures a new control signal by using the digital data obtained from the digital block.

According to another aspect of the present invention, there is provided a method of controlling an analog block in which audio/video data is received by a data receiver having the analog block and a digital block, the method including: determining whether to reconfigure a control signal of the analog block; determining a new control signal if the control signal is determined to be reconfigured; and generating an electrical signal in response to the new control signal and feeding the generated electrical signal back to the analog block.

According to another aspect of the present invention, there is provided a history update method for controlling an analog block in which audio/video data is received by a data receiver having the analog block and a digital block, the method including: modifying a control signal of the analog block; calculating an error frequency by using digital data obtained from the digital block; and determining priority order of the control signal on the basis of the error frequency.

### BRIEF DESCRIPTION OF THE DRAWINGS

The above and other features of the present invention will become more apparent by describing in detail exemplary embodiments thereof with reference to the attached drawings in which:

FIG. 1 is a functional block diagram schematically illustrating a high definition multimedia interface (HDMI) receiver according to an exemplary embodiment of the present invention;

FIG. 2 is a block diagram illustrating a structure of a digital block of FIG. 1;

FIG. 3 is a block diagram illustrating a structure of a transition minimized differential signaling (TMDS) analog block controller of FIG. 2;

FIG. 4 is a flowchart illustrating a method of controlling a TMDS reception analog block;

FIG. 5 is a flowchart illustrating operations carried out in a history update operation; and

FIG. 6 illustrates an example of a history table used in a method of controlling a TMDS reception analog block according to an exemplary embodiment of the present invention.

### DETAILED DESCRIPTION OF THE INVENTION

Hereinafter, exemplary embodiments of the present invention will be described in detail with reference to the accompanying drawings.

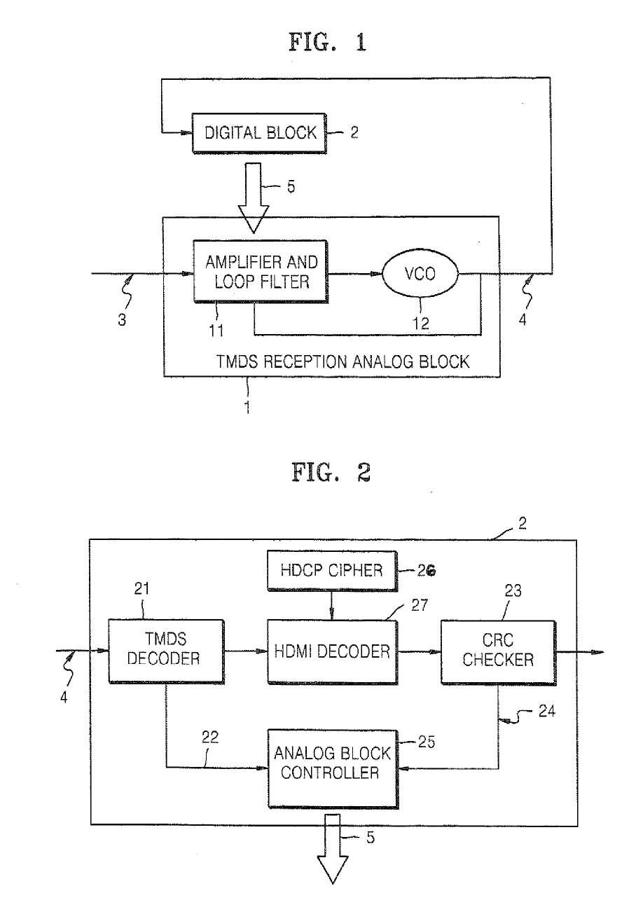

FIG. 1 is a functional block diagram schematically illustrating a high definition multimedia interface (HDMI) data receiver according to an exemplary embodiment of the present invention The HDMI data receiver includes a transition minimized differential signaling (TMDS) reception analog block 1 and a digital block 2.

The TMDS reception analog block 1 restores TMDS encoded analog data 3 received by the HDMI data receiver to TMDS encoded digital data 4 and also removes noise. The TMDS reception analog block 1 includes an amplifier 11, a loop filter 11, and a voltage controlled oscillator (VCO) 12. The digital block 2 processes the digital data restored by the TMDS reception analog block 1 so that the digital data can be restored to an original video or audio signal. The digital block 2 uses the encoded digital data 4 output from the TMDS reception analog block 1 (hereinafter, briefly referred to as analog block) and thus generates a feedback signal 5 to control the analog block 1.

FIG. 2 is a block diagram illustrating a structure of the digital block 2 of FIG. 1.

The digital block 2 includes a TMDS decoder 21, a high-bandwidth digital content protection (HDCP) cipher 26, a HDMI decoder 27, a cyclic redundancy check (CRC) checker 23, and an analog block controller 25.

A TMDS data stream output from the analog block 1 undergoes a TMDS decoding process and a HDMI decoding process so as to be restored to video/audio data.

The analog block controller 25 uses digital data 22 output from the TMDS decoder and digital data 24 output from the CRC checker 23 as an input signal for generating a control signal. The reason for the above is that a TMDS decoding error and a CRC decoding error are generally caused by a noise characteristic of a TMDS channel and therefore clearly show a characteristic/state of a TMDS channel. According to another exemplary embodiment of the present invention, besides the aforementioned outputs (22, 24), any signal may be used as long as the signal correctly shows a noise characteristic of the TMDS channel.

The analog block controller 25 uses the output data 22 and 24 to generate an analog block control signal 5 and thereafter feeds back the generated analog block control signal 5 to the analog block 1.

The control signal 5 may be a combined control signal composed of two or more signal components. The analog block 1 generally includes a sense amplifier and a loop filter. Therefore, the analog block control signal 5 may include a control signal for controlling a sensitivity of the sense amplifier and a control signal for controlling an equalization coefficient of the loop filter.

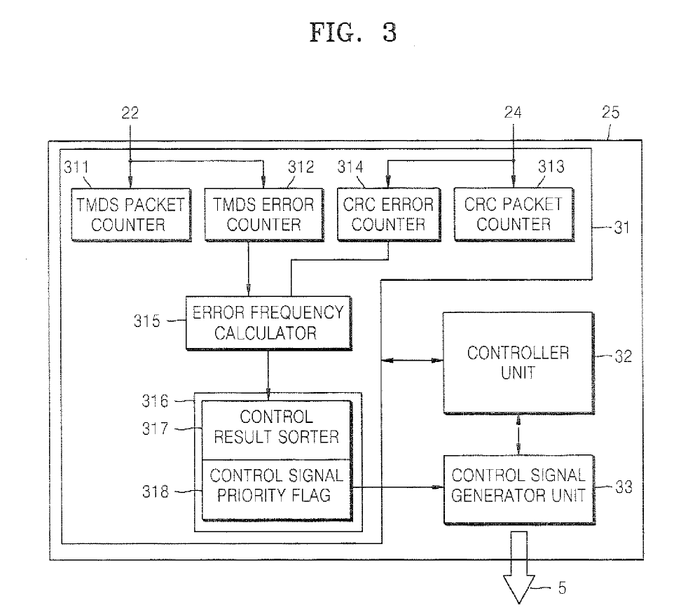

FIG. 3 is a block diagram illustrating a structure of the TMDS reception analog block controller 25 of FIG. 2.

The analog block controller 25 includes a control signal determining unit 31, a controller unit 32, and a control signal generator unit 33.

The controller unit 32 determines whether to reconfigure a control signal required to control the analog block 1. In this process, the determination is made by the controller unit 32 in consideration of an error frequency of received data, a cable type, a cable length, a data receiver type, and the like. For example, the controller unit 32 may determine to reconfigure the analog block control signal if a transmission channel environment changes, that is, an error frequency of data received by the HDMI data receiver increases to above 10⁻¹⁰[errors/packet] or a data transmitter (source) type (e.g., a model and a manufacturer of a set-up box (STB) or a digital video disk (DVD) player) changes.

The control signal determining unit 31 determines, i.e., generates, a new control signal for reconfiguring the analog block control signal 5. The control signal determining unit 31 includes a TMDS packet counter 311, a TMDS error counter 312, a CRC packet counter 313, a CRC error counter 314, an error frequency calculator 315, and a priority ordering unit 316.

The TMDS packet counter 311 and the TMDS error counter 312 each use digital data 22 output from the TMDS decoder so as to count the number of packets and the number of errors included in the packets.

The CRC packet counter 313 and the CRC error counter 314 each use output 24 of the CRC checker 23 so as to count the number of CRC packets and the number of errors included in the packets.

The error frequency calculator 315 uses the number of packets and the number of errors respectively obtained from the packet counters 311 and 313 and the error counters 312 and 314 so as to calculate an error frequency (e.g., error frequency =number of errors/number of packets).

The priority ordering unit 316 includes a control result sorter 317 and a control signal priority flag 318.

The control result sorter 317 is a buffer memory that is used to sort control signals according to the error frequency calculated by the error frequency calculator 315. The control signal may be a combined control signal for controlling the sensitivity of the amplifier or the coefficient of the loop filter.

The control signal priority flag 318 is used to assign priorities to the control signals according to the control signal priority determined by the control result sorter 317. The top priority is assigned to a control signal that shows the most suitable error frequency.

The control signal generator unit 33 generates an electrical control signal corresponding to a control signal whose priority is determined by the priority ordering unit 316, and then feeds back the generated electrical control signal to the analog block 1. Accordingly, the control signal of the analog block 1 is reconfigured.

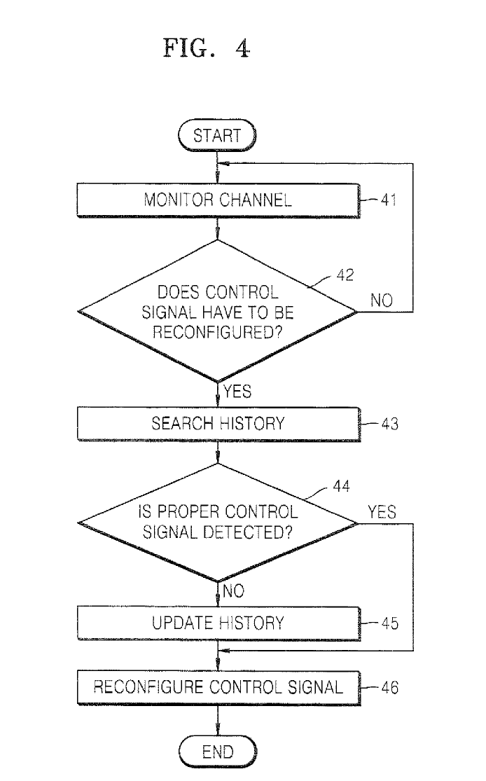

FIG. 4 is a flowchart illustrating a method of controlling the analog block 1.

In operation 41, a state of a TMDS transmission channel is monitored. The reason for monitoring the state of the transmission channel is to determine whether the analog block control signal 5 needs to be reconfigured. In this operation, the state of the transmission channel or an environment change is observed, for example, an error frequency of received data, a cable type, a cable length, and a data transmitter (source) type are observed.

In operation 42, whether to reconfigure the control signal is determined according to the monitoring result obtained in operation 41. For example, the determination may be made so that the control signal is reconfigured when the error frequency of data received from the HDMI data receiver increases to above 10⁻¹⁰[errors/packet]. If the determination result shows that the control signal does not have to be reconfigured, the state of the transmission channel is continuously monitored, returning back to operation 41.

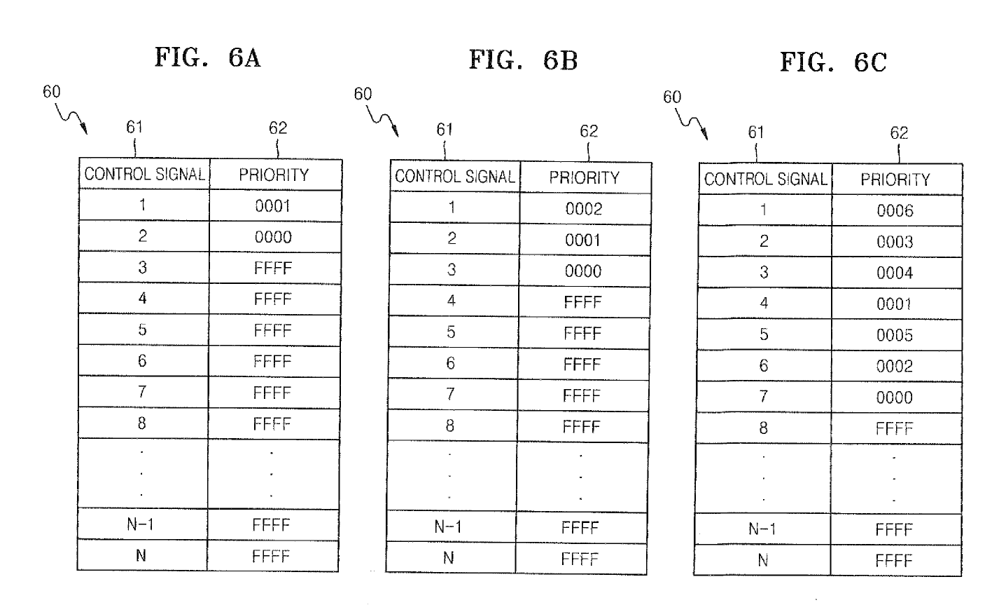

If the determination result of operation 42 shows that the control signal has to be reconfigured, a history of the control signal is searched (operation 43). The history is written in a table in which error frequencies of various control signals and priorities assigned thereto are contained (see FIG. 6). First, a control signal having a more suitable error frequency than that of a current control signal is searched for from the history table (of course, the error frequency is less than or equal to the aforementioned critical value, that is, 10⁻¹⁰[errors/packet]).

In operation 44, if a new suitable control signal is detected in operation 43, the control signal is used to reconfigure an analog block control signal 5 (operation 46), and then the process is terminated.

If no suitable control signal is detected in operation 43, the procedure goes to operation 45 so as to update the history.

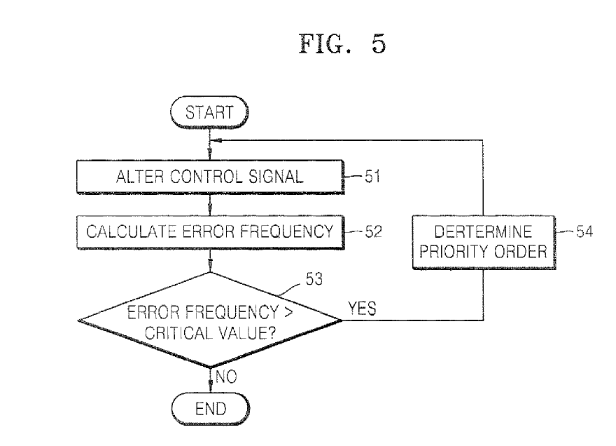

In operation 45, the history is updated. In this operation, in order to find out a new suitable analog block control signal 5, the error frequency is observed whether it is increased or decreased while arbitrarily altering the control signal of the analog block 1. Detailed operations thereof will be further described later with reference to FIG. 5.

In operation 46, the control signal of the analog block 1 is reconfigured. In this operation, an electrical control signal is generated to control the analog block 1 according to the new control signal obtained in operation 43 or operation 45, and then the generated electrical control signal is fed back to the analog block 1.

FIG. 5 is a flowchart illustrating operations carried out in history update operation 43.

In operation 51, a control signal is altered to a new control signal different from the current control signal. Accordingly, values of elements of the analog block 1 (e.g., an amplifier sensitivity and a filter coefficient) are modified to values corresponding to the new control signal.

In operation 52, an error frequency of a TMDS channel is calculated wherein the error frequency is generated under a new environment formed by the new control signal obtained in operation 51. The number of packets counted by the packet counters 311 and 313 and the number of errors counted by the error counters 312 and 314 are used to calculate the error frequency (e.g., error frequency=number of errors/number of packets).

In operation 53, priority order of the control signals are determined. An error frequency of a previous control signal is compared with an error frequency of a new control signal. If the error frequency of the new control signal is less than that of the previous control signal, the new control signal is assigned with higher priority.

In operation 54, the error frequency of the new control signal is compared with the critical value (e.g., 10⁻¹⁰[errors/packet]). If the error frequency is greater than the critical value, priority order of the control signals are determined (operation 54), and thereafter, operations 51 to 53 are repeated.

On the other hand, if the error frequency is less than or equal to the critical value, the modified control signal is used as the new control signal to control the analog block 1.

FIG. 6 illustrates an example of a history table used in a method of controlling the analog block 1 according to an exemplary embodiment of the present invention.

History update operation 45 of FIG. 4 will now be described again with reference to the history table of FIG. 6.

The history table 60 may include a control signal item 61 and a priority item 62.

The control signal item 61 corresponds to combinations of signals required to control the analog block 1 (e.g., the sensitivity of the amplifier, the equalization coefficient of the filter, etc). Not an actual combination control signal but error frequencies of respective combination control signals are stored in the control signal item 61.

Priorities for respective control signals determined according to the error frequencies are stored in the priority item 62. A control signal causing a relatively high error frequency has lower priority (larger number). However, the highest priority (0000) is assigned to a control signal whose error frequency is currently being calculated, whereas the lowest priority (FFFF) is assigned to a control signal whose error frequency is not yet calculated.

Referring first to FIG. 6(a), an error frequency of a control signal 1 is greater than the critical value. Thus, a low priority (0001) is assigned to the control signal 1. An error frequency of a control signal 2 is currently being calculated, and thus the top priority (0000) is assigned to the control signal 2.

If the error frequency calculation result shows that the error frequency of the control signal 2 is less than the error frequency of the control signal 1, a higher priority (0001) is assigned to the control signal 2 (see FIG. 6(b)). However, if the error frequency of the control signal 2 does not satisfy the critical value, the error frequency of a control signal 3 has to be calculated.

Likewise, a new control signal undergoes the error frequency calculation and the result is compared with the critical value. For example, as shown in FIG. 6(c), if an error frequency of a control signal 7 is determined to be less than or equal to the critical value, the control signal 7 is determined as the new control signal and then the history update operation is terminated (the top priority (0000) has already been assigned to the control signal 7).

The control signal generator unit 33 determines the control signal 7 as the new control signal and then feeds back an electrical control signal to the analog block 1.

According to a method and apparatus for controlling an analog block of the present invention, errors of received data can be more effectively prevented than in the conventional controllers since environment changes of a transmission channel can be adaptively handled. Therefore, a user can use a data receiver with high quality at the same cost.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. An apparatus which controls an analog block of a data receiver having the analog block and a digital block, the apparatus comprising:
a controller unit which determines whether to reconfigure a control signal required to control the analog block to generate a determination result;
a control signal determining unit which generates a new control signal by using digital data obtained from the digital block according to the determination result of the controller unit; and
a control signal generator unit which generates an electrical control signal corresponding to the new control signal determined by the control signal determining unit.

2. The apparatus of claim 1, wherein the control signal determining unit includes an error frequency calculator.

3. The apparatus of claim 2, wherein the error frequency calculator calculates an error frequency by using at least one of an output of a transition minimized differential signaling (TMDS) decoder and an output of a cyclic redundancy check (CRC) checker, wherein the TMDS decoder and the CRC checker are included in the digital block.

4. The apparatus of claim 1, wherein the control signal determining unit includes a packet counter and an error counter.

5. The apparatus of claim 1, wherein the control signal determining unit includes a priority ordering unit which determines a priority order of the control signal.

6. The apparatus of claim 5, wherein the priority ordering unit includes a control result sorter and a control signal priority flag.

7. The apparatus of claim 1, wherein the control signal includes at least one of an amplifier sensitivity and a loop filter coefficient of the analog block.

8. The apparatus of claim 1, wherein the controller unit determines whether to reconfigure the control signal in consideration of at least one of an error frequency of received data, a cable type, a cable length, and a transmitter type.

9. The apparatus of claim 8, wherein the controller unit determines to reconfigure the control signal if the error frequency of the received data is greater than a predetermined critical value.

10. A data receiver comprising:
an analog block which restores analog data received from a transmission channel to digital data;
a digital block which decodes the digital data restored by the analog block to audio/video data; and
an analog block controller which controls the analog block, wherein the analog block controller reconfigures a new control signal by using the digital data obtained from the digital block.

11. The data receiver of claim 10, wherein the data receiver is a part of an interface in compliance with a high definition multimedia interface (HDMI) standard.

12. The data receiver of claim 10, wherein the analog block is a transition minimized differential signaling (TMDS) reception analog block.

13. The data receiver of claim 10, further comprising a TMDS decoder and a cyclic redundancy check (CRC) checker.

14. The data receiver of claim 13, wherein the analog block controller controls the analog block by using at least one of an output of the TMDS decoder and an output of the CRC detector.

15. A method of controlling an analog block in which audio/video data is received by a data receiver having the analog block and a digital block, the method comprising:
determining whether to reconfigure a control signal of the analog block;
generating a new control signal if the control signal is determined to be reconfigured; and
generating an electrical signal in response to the new control signal and feeding the generated electrical signal back to the analog block.

16. The method of claim 15, wherein in the determining whether to reconfigure the control signal, a determination is made in consideration of at least one of an error frequency of the received data, a cable type, a cable length, and a type of a device connected to a data transceiver.

17. The method of claim 16, wherein in the determining whether to reconfigure the control signal, the control signal is determined to be reconfigured if the error frequency of the received data is greater than a predetermined critical value.

18. The method of claim 16, wherein the error frequency of the received data is calculated by using digital data obtained from the digital block.

19. The method of claim 15, wherein the generating of the new control signal comprises searching a history of the control signal.

20. The method of claim 15, wherein the generating of the new control signal comprises updating a history of the control signal.

21. A history update method for controlling an analog block in which audio/video data is received by a data receiver having the analog block and a digital block, the method comprising:
modifying a control signal of the analog block;
calculating an error frequency by using digital data obtained from the digital block; and
determining priority order of the control signal on the basis of the error frequency.

22. The history update method of claim 21, wherein the control signal of the analog block is a combined control signal including two or more signals.

23. The history update method of claim 22, wherein the combined control signal includes at least one of an amplifier sensitivity and a loop filter coefficient of the analog block.

24. The history update method of claim 21, wherein the determining priority order comprises assigning priority by sorting control signals on the basis of the error frequency.
